(19) United States
(12) Patent Application Publication
(10) Pub. No.: US 2021/0166190 A1
(43) Pub. Date: Jun. 3, 2021

(54) LOCATION SPECIFIC RFID TAG AND METHOD OF USE

(71) Applicant: Derrick Woodard, Memphis, TN (US)

(72) Inventor: Derrick Woodard, Memphis, TN (US)

(21) Appl. No.: 16/699,498

(22) Filed: Nov. 29, 2019

(51) Int. Cl. G06Q 10/08; G06K 19/07

(52) U.S. Cl. CPC G06Q 10/0833; G06K 19/0723

(57) ABSTRACT

An RFID tag is provided. The tag confirms the arrival of a, e.g., courier at a specified address once scanned. The barcode number on the tag is registered to the address of the property where it is located, and the tag is permanently located at that specific address. The address and associated barcode information are stored on a central server, and the permanent address is written on the tag. Thus, the barcode information is a digitized representation of a specific address. When delivering couriers drop a package, which may have its own tracking number to be scanned using a separate tracking system, the courier or delivery person will scan the tracking number of the package being delivered, and then the courier will scan the barcode of the RFID tag with a reader, and a display on the reader will show the actual address of where the package was delivered, as this information is stored on the chip embedded in the RFID tag. When the courier scans the RFID tag it will update to the central server the location and time of delivery by transmitting the digitized barcode information associated with the tag. If there is a tracking number associated with the package the tracking number is transmitted along with the digitized barcode information. Optionally, a barcoded serial number is used without an RFID chip, the serial number associated with an address and stored on a central computer.

### CROSS REFERENCE TO RELATED APPLICATIONS

This application claims priority from U.S. Provisional No. 62/917,248 filed on Nov. 30, 2018, confirmation number 9630.

### BACKGROUND OF THE INVENTION

### 1. Field of the Invention

This invention relates to package delivery and tracking. More specifically, it relates to a method and system of tracking packages using RFID tags.

### 2. Description of the Prior Art

RFID tags have been used for years to identify and track packages routed through a delivery system. The tags are generally deployed within or on the package itself and then scanned for digital information. The digital information is then uploaded to a central server for processing. A typical delivery system employing an RFID device is described in U.S. Pat. No. 5,497,140 issued to J. R. Tuttle on Mar. 5, 1996 discloses an electrically-powered postage shipping label which includes a radio frequency identification (RFID) device and system mounted between the opposing major surfaces of the stamp. The RFID device and system includes an integrated circuit transceiver chip which is connected to and powered by a thin flat battery cell. The transceiver chip is operated in association with a thin RF antenna, all of which are mounted in a side-by-side relationship on a thin base support layer of the stamp/label. These thin, flat components are mounted in an essentially two-dimensional planar configuration that is well-suited for incorporation into the conventional planar structure of a postage stamp or mailing label. As disclosed therein, the Tuttle RFID system is used to provide tracking information from dispatch to delivery. The Tuttle system uses an “active” RFID device, requiring each stamp/label to include batteries (albeit relatively small, planar batteries).

While the Tuttle system is generally satisfactory for its intended use it suffers from the drawback that the actual location of the delivery person when he scans the tag is unknown. The actual physical address is not known and cannot be positively verified.

In accordance with the present invention, an RFID tag is provided. The tag confirms the arrival of a, e.g., courier at a specified address once scanned. The barcode number on the tag is registered to the address of the property where it is located, and the tag is permanently located at that specific address. The address and associated barcode information are also stored on a central server, and the permanent address is written on the tag. Thus, the barcode information is a digitized representation of a specific address. When delivering couriers drop a package, which may have its own tracking number to be scanned using a separate tracking system, the courier or delivery person will scan the tracking number of the package being delivered, and then the courier will scan the barcode of the RFID tag with a reader, and a display on the reader will show the actual address of where the package was delivered, as this information is stored on the chip embedded in the RFID tag. When the courier scans the RFID tag it will update to the central server the location and time of delivery by transmitting the digitized barcode information associated with the tag. If there is a tracking number associated with the package the tracking number is transmitted along with the digitized barcode information. Optionally, a barcoded serial number associated with a specific address is used on a tag without an RFID chip, the serial number associated with an address and stored on a central computer.

It is to be understood that an advantage of the present invention is that the RFID tag will have the actual permanent address written on it. This information is also digitally stored on the tag so that the courier, or any other person with access to the central server, can scan the RFID tag and verify the address associated with the tag. Thus, e.g., first responders may either read or scan the tag to verify that they are at the correct address, which is helpful when the address of the property associated with the tag cannot be easily determined, e.g., darkness or inclement weather.

### SUMMARY OF THE INVENTION

It is a major object of the invention to provide an improved tracking system for packages.

It is another object of the invention to provide an improved tracking system for packages which uses an RFID tag.

It is another object of the invention to provide an improved tracking system for packages where the RFID scanner includes a visible display.

It is another object of the invention to provide an improved tracking system for packages where the RFID tag displays the address of the location where it is permanently mounted.

### BRIEF DESCRIPTION OF THE DRAWINGS

FIG. 1 depicts scanning an RFID tag deployed in accordance with the invention, the tag affixed to a mailbox.

FIG. 2 is a diagrammatic illustration of the environment of the invention.

### DETAILED DESCRIPTION OF THE PREFERRED EMBODIMENTS

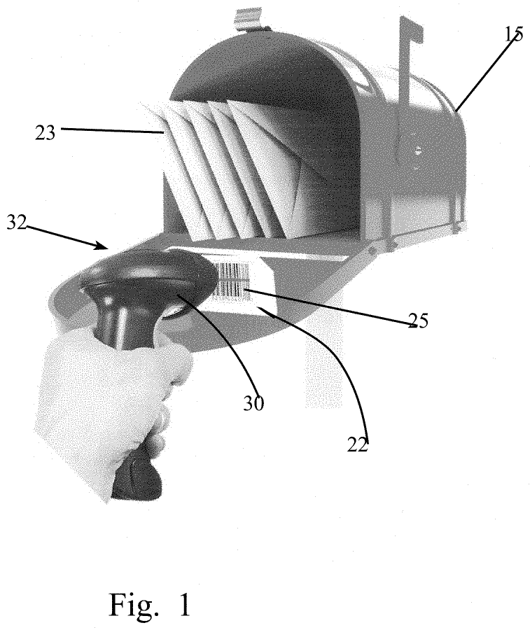

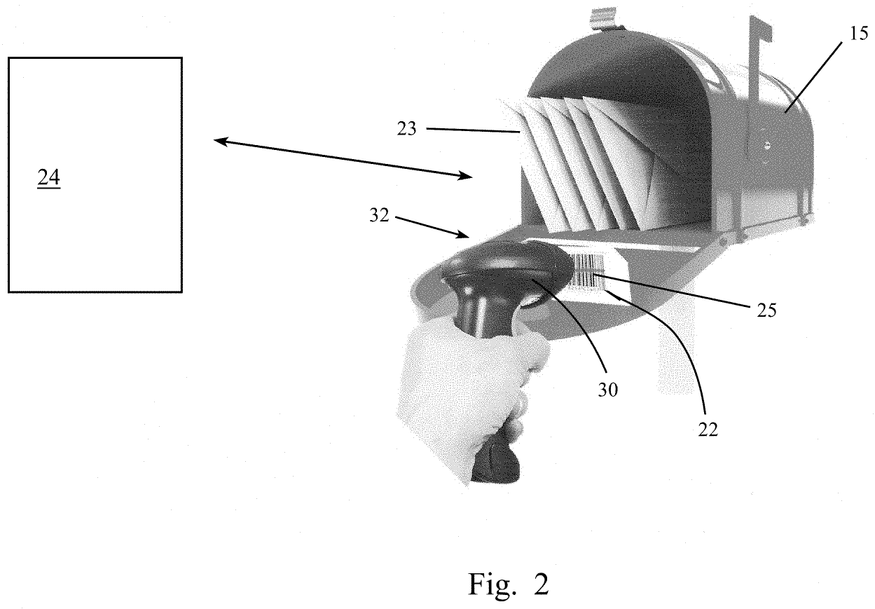

Referring now to FIGS. 1 and 2, the apparatus of the invention, generally indicated by the numeral 10, is shown. The apparatus includes a barcode tag 20, which is essentially a weatherproof adhesive plastic strip 22 within which a radio frequency tag 25 may be inserted bearing digital information including the address information data. The tag 20 may be affixed to or within a mailbox 15, on or near a front door, or other location at the destination address. The address of the tag's 20 location is also written on it for the courier or delivery person so they can ascertain their exact location. The address stored and written on the tag 20 is the “permanent” address, which may be a home or business. Every time a package 23 is delivered to the permanent address the package 23 is scanned for tracking data (if any) and then the tag 20 is scanned, and the address information data obtained from the scan of the tag 20 is forwarded to a central server 24 along with the tracking data so that the system records a delivery to that address. The written portion of the tag 20 may be separate or detachable from the main body of the tag 20 and may have a surface which allows for eraseably writing in an address. This address can also be determined by scanning the tag 20 using an RFID scanner or reader 30 with a display 32, this capability serving as a backup to the written address.

Optionally, the tag 20 may not have an RFID chip, and simply have a barcoded serial number imprinted onto it. In this case, the courier will simply scan the tag 20 with reader 30, the reader 30 then communicating with the server 24 to transmit the barcode information associated with the tag 20, the server 24 then transmitting the specific address associated with the tag's barcode information back to the reader 30 so that the address associated with the barcode information is displayed on the reader 30.

The RFID tag 20 will be GPS capable, so that the exact position of the tag 20 can be known by simply scanning the RFID tag 20 to get an accurate reading. It should be noted that the system of the present invention is intended to provide the position of the courier or delivery person when the package 23 is delivered, scanning of RFID tag 20 confirms that the courier was at the location of the permanent address associated with the barcoded information shown on and stored in the tag 20. Continual tracking of the tag 20 is not an aspect of the invention as the primary purpose of the tag 20 is to verify delivery of the package in the event the intended recipient claims the package 23 was lost/never received.

As is known in the art, it is common to have tracking data associated with a package 23. This tracking data is typically not RFID enabled, that is, the package 23 is scanned for tracking data and then is e.g., loaded onto a van or truck. The end recipient will see that the package is en route. When the package 23 is delivered it is scanned and then dropped. The exact position of the courier is not known, it is simply assumed that the package 23 was scanned while at the delivery address. By contrast, with the present inventive method, when the package 23 is delivered, the RFID tag 20 positioned at the intended designation address is scanned, so that the physical location of the courier at time of delivery is known, and this information is forwarded to the central server 24.

The system of the invention may optionally include conventional means for tracking the package 23, so that both tracking data and delivery time are transmitted from the same reader 30. However, it is intended that a third party tracking system be used with the present invention. Thus, for example, a mailman using the USPS tracking system, can scan the package 23 (using a USPS reader) and update the tracking info with the USPS server. The mailman will then scan the tag 20 which will send the barcode information associated with the tag 20 (i.e., the digitized version of the permanent physical address to which the barcode information corresponds) to the server 24 associated with the system of the present invention to record a delivery on the server 24. Thus, the inventive system can allow for the location of the courier at the time of delivery to be indisputably ascertained, as it is impossible to scan tag 20 if not at the physical location (i.e., the “permanent address”) where the tag 20 is located.

In use, once the package 23 is delivered, the courier/mailman will scan the package 23 to get the tracking data, if available. This tracking data may be transmitted to a third party server to indicate delivery status. Otherwise, after the package 23 is delivered, the courier simply scans tag 20 to read and display the current address associated with the tag 20, and to send the current delivery status to server 24. In the case of a mailman, the user will know that the mailman has come that day, and will know the exact time of delivery. A user using the system of the invention, can then access server 24 to see if any delivery has happened. If the inventive system includes the optional package tracking, then a user of the inventive system can also check server 24 for package tracking data. Otherwise, the user simply checks the delivery status using the third party tracking systems associated with the shipper (USPS, UPS, FEDEX). The courier/mailman scanning the tag 20 both visually and using reader 30 allows the exact address as determined by the GPS portion of the tag 20 to be ascertained.

It can be readily appreciated that the capability disclosed by this inventive system could be integrated with known third party tracking systems. In this scenario, the courier/mailman will first scan the package 23, then the tag 20, to transmit both tracking and address (location) information to a central server so that both data can be available to the user on a single website.

It is to be understood that the present invention is not limited to the sole embodiment described above, but encompasses any and all embodiments within the scope of the following claims:

I claim:

1. A method of ascertaining location of a package to be delivered comprising the steps of:
preparing an RFID tag by initiating said tag with a permanent address and permanently affixing said tag at said permanent address;
displaying said address on a display portion of the tag;
transmitting said permanent address to a central location for accessible storage;
shipping said package to a destination;
scanning said tag upon delivery of said package and generating time and location data; and
transmitting said time and location data to said central server to verify location of said package.

2. The method of claim 1 wherein said package has associated tracking data, further comprising the step of transmitting said tracking data with said time and location data.
